(19) United States
(12) Patent Application Publication
(10) Pub. No.: US 2026/0221614 A1
(43) Pub. Date: Jul. 30, 2026

(54) CELL AND ELECTRONIC DEVICE

(71) Applicant: HUIZHOU LIWINON NEW ENERGY TECHNOLOGY CO., LTD., Huizhou (CN)

(72) Inventors: Weiyuan YU, Huizhou (CN); Yunlei GAO, Huizhou (CN); Zilong YU, Huizhou (CN); Jie CHEN, Huizhou (CN)

(21) Appl. No.: 19/629,653

(22) Filed: Mar. 26, 2026

Related U.S. Application Data
(63) Continuation-in-part of application No. PCT/CN2024/118517, filed on Sep. 12, 2024.

(30) Foreign Application Priority Data
Mar. 19, 2024 (CN) 202420537073.3

(51) Int. Cl. H01M 50/533; H01M 50/105; H01M 50/178

(52) U.S. Cl. CPC H01M 50/533; H01M 50/105; H01M 50/178

(57) ABSTRACT

A cell includes an electrode assembly, a first tab, a second tab, and a packaging member. The first tab and the second tab are respectively connected to the electrode assembly. The first tab and the second tab are located on the same side of the electrode assembly. The packaging member includes an electrode assembly accommodating portion and a tab packaging portion in communication with the electrode assembly accommodating portion. The tab packaging portion extends away from the electrode assembly accommodating portion in a first direction. A size of the tab packaging portion is smaller than that of the electrode assembly accommodating portion in a second direction. The first tab and the second tab are provided with a bending portion extending in a thickness direction of the electrode assembly. The electrode assembly is accommodated in the electrode assembly accommodating portion. The bending portions are accommodated in the tab packaging portion.

### CROSS-REFERENCE TO RELATED APPLICATIONS

This application is a bypass continuation-in-part of international application No. PCT/CN2024/118517, filed September 12, 2024, which claims priority to Chinese patent application No. 202420537073.3 filed March 19, 2024. The contents of these applications are incorporated herein by reference in their entirety.

### TECHNICAL FIELD

The present disclosure relates to the technical field of batteries, and particularly to a cell and an electronic device.

### BACKGROUND

Batteries are widely used in various electronic products, such as mobile phones and notebook computers. With the continuous upgrading of these products, increasing the energy density of batteries has become a main trend in battery development. In practical production, the structure of the electrode assembly or the housing is typically improved by increasing the space utilization of the packaged battery and reducing the space waste of the battery housing, thereby increasing the energy density of the battery.

In related technologies, during battery packaging, tabs are folded and the folded parts are placed in the housing, so that the space occupied by the tabs is reduced, thereby increasing the energy density of the battery. However, such an approach still fails to use the space between the housing and the electrode assembly where the tabs are not provided, resulting in considerable waste of space and affecting the energy density of the battery.

### SUMMARY

The present disclosure aims to at least solve one of the technical problems in the related art. Therefore, the present disclosure provides a cell, which can alleviate the problem in the existing technology that considerable space between the electrode assembly and the casing is wasted during cell packaging and the energy density of the cell is affected.

The present disclosure further provides an electronic device including the cell.

In accordance with a first aspect of the present disclosure, an embodiment provides a cell, which includes an electrode assembly, a first tab, a second tab, and a packaging member. The first tab is connected to the electrode assembly. The second tab is connected to the electrode assembly. The first tab and the second tab are located on the same side of the electrode assembly. The packaging member includes an electrode assembly accommodating portion and a tab packaging portion. The tab packaging portion is in communication with the electrode assembly accommodating portion. The tab packaging portion extends away from the electrode assembly accommodating portion in a first direction. A size of the tab packaging portion is smaller than a size of the electrode assembly accommodating portion in a second direction. The first direction is perpendicular to the second direction. The first tab and the second tab are each provided with a bending portion extending in a thickness direction of the electrode assembly. The electrode assembly is accommodated in the electrode assembly accommodating portion. The bending portions are accommodated in the tab packaging portion.

The cell according to the embodiments of the present disclosure at least has the following beneficial effects. In the cell, the first tab and the second tab are respectively connected to the same side of the electrode assembly. When the cell is applied to a device, the device may be provided with an input end corresponding to the first tab and the second tab of the electrode assembly to electrically connect to the first tab and the second tab to ensure power supply. As such, the rationality of the layout of the components in the device and the convenience of mounting the cell are improved. During packaging, when the electrode assembly, the first tab, and the second tab are packaged by the packaging member, the electrode assembly is accommodated in the electrode assembly accommodating portion of the packaging member, and the bending portions are accommodated in the tab packaging portion extending away from the electrode assembly accommodating portion in the first direction. As such, the electrode assembly accommodating portion and the tab packaging portion of the packaging member can be respectively designed according to actual dimensions of the electrode assembly, the first tab, and the second tab, thereby reducing the waste of space caused by designing the dimensions of the packaging member based on the space required by the bending portions with no tab area being provided in the packaged cell. Such a method can not only increase the energy density of the packaged cell, but also reduce the unoccupied space between the packaging member and the electrode assembly where no tab region is provided, making the overall structure of the packaged electrode assembly more compact, and making the electrode assembly less likely to shake in the electrode assembly accommodating portion, thereby improving the stability of the cell.

In addition, the size of the tab packaging portion in the second direction is smaller than the size of the electrode assembly accommodating portion, to facilitate localization of the packaging positions of the tabs and the electrode assembly while reducing the volume of the cell after packaging, thereby improving the packaging precision and packaging speed.

According to some embodiments of the present disclosure, the tab packaging portion includes a first packaging portion and a second packaging portion, the first tab is accommodated in the first packaging portion, and the second tab is accommodated in the second packaging portion, where the first packaging portion and the second packaging portion are arranged spaced apart from each other in the second direction.

According to some embodiments of the present disclosure, opposing edges of the first packaging portion and the second packaging portion are respectively arranged to be flush with an edge of the electrode assembly accommodating portion in the second direction.

According to some embodiments of the present disclosure, an accommodating cavity is defined between any edge of the first tab in the second direction and an inner side wall of the first packaging portion opposite to the edge, and a size of the accommodating cavity in the second direction is 2.0 mm to 15.0 mm; and/or an accommodating cavity is defined between any edge of the second tab in the second direction and an inner side wall of the second packaging portion opposite to the edge, and a size of the accommodating cavity in the second direction is 2.0 mm to 15.0 mm.

According to some embodiments of the present disclosure, the electrode assembly includes an electrode assembly body, a first tab portion, and a second tab portion, the first tab portion and the second tab portion are connected to the electrode assembly body and protrude from the electrode assembly body, the first tab portion is connected to the first tab, and the second tab portion is connected to the second tab; and the first tab portion protrudes from the first tab in the second direction to form a protruding portion, and the protruding portion is accommodated in the accommodating cavity; and/or the second tab portion protrudes from the second tab in the second direction to form a protruding portion, and the protruding portion is accommodated in the accommodating cavity.

According to some embodiments of the present disclosure, the tab packaging portion is provided with a tab packaging cavity, and the bending portions of the first tab and the second tab are accommodated in the tab packaging cavity.

According to some embodiments of the present disclosure, one edge of the tab packaging portion in the second direction is arranged to be flush with an edge of the electrode assembly accommodating portion.

According to some embodiments of the present disclosure, a size of the tab packaging portion in the first direction is 0.3 mm to 5.0 mm.

According to some embodiments of the present disclosure, a distance from one edge of the electrode assembly facing the tab packaging portion in the first direction to one edge of the tab packaging portion away from the electrode assembly accommodating portion is 0.5 mm to 5.5 mm.

In accordance with a second aspect of the present disclosure, an embodiment provides an electronic device including the cell according to the embodiments in the first aspect of the present disclosure.

The electronic device according to the embodiments of the present disclosure at least has the following beneficial effects. The cell is accommodated in the accommodating cavity to supply power to the electronic device. The overall volume of the cell is reduced and the energy density is increased, because the unoccupied space between the packaging member and the electrode assembly where no tab region is provided is reduced in the cell. When installed in the electronic device, the cell occupies a small part of the mounting space in the electronic device, which is conducive to improving the flexibility and rationality of the layout of the components in the electronic device.

Additional aspects and advantages of the present disclosure will be partly given in and partly apparent from the description below, or understood through practice of the present disclosure.

### BRIEF DESCRIPTION OF DRAWINGS

The present disclosure will be further described below with reference to the accompanying drawings and embodiments. In the drawings:

FIG. 1 is a schematic structural diagram of a cell according to an embodiment of the present disclosure;

FIG. 2 is a schematic structural diagram of the cell shown in FIG. 1 when viewed from another angle;

FIG. 3 is a schematic structural diagram of a cell according to another embodiment of the present disclosure;

FIG. 4 is a partially enlarged view of part A in FIG. 3; and

FIG. 5 is a schematic structural diagram of a cell according to still another embodiment of the present disclosure;

FIG. 6 is a schematic structural diagram of a cell according to still another embodiment of the present disclosure.

List of reference numerals:

cell 100;

electrode assembly 110, electrode assembly body 111;

first tab 120;

second tab 130;

bending portion 140;

packaging member 150; electrode assembly accommodating portion 151; tab packaging portion 152; first packaging portion 1521; second packaging portion 1522; accommodating cavity 1523; tab packaging cavity 1524;

first tab portion 160, protruding portion 161;

second tab portion 170, protruding portion 171.

### DETAILED DESCRIPTION

Embodiments of the present disclosure will be described in detail hereinafter in conjunction with accompanying drawings in which the same or like reference characters refer to the same or like elements or elements having the same or like functions throughout. The embodiments described below by reference to the accompanying drawings are illustrative and are intended for illustrating only and are not to be construed as limiting the present disclosure.

In the description of the present disclosure, it should be understood that for the description of orientations, the orientation or positional relationships indicated by the terms such as “upper,” “lower,” “front,” “rear,” “left,” “right,” and the like are based on orientation or positional relationships shown in the accompanying drawings, and are used only for ease and brevity of illustration and description, rather than indicating or implying that the mentioned apparatus or element must have a particular orientation or must be constructed and operated in a particular orientation. Therefore, such terms should not be construed as limiting of the present disclosure.

In the description of the embodiments of the present disclosure, the term “several” means one or more, the term “plurality of” (or multiple) means two or more, the term such as “greater than,” “less than,” “exceed” or variants thereof prior to a number or series of numbers is understood to not include the number adjacent to the term. The term “above,” “below,” “within” prior to a number or series of numbers is understood to include the number adjacent to the term. If used herein, the terms such as “first,” “second,” and the like are merely used for distinguishing technical features, and are not intended to indicate or imply relative importance, or implicitly point out the number of the indicated technical features, or implicitly point out the precedence order of the indicated technical features.

In the description of the present disclosure, unless otherwise explicitly defined, the terms such as “configure,” “install/mount” and “connect” should be understood in a broad sense, and those having ordinary skills in the art can reasonably determine the specific meanings of the above terms in the present disclosure based on the specific contents of the technical scheme.

In the description of the present disclosure, the description with reference to the terms “an embodiment,” “some embodiments,” “example embodiment,” “example,” “specific example,” or “some example” and so on means that specific features, structures, materials or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments.

An electrode assembly 110 formed by winding or laminating electrode sheets may have a plurality of electrode-sheet tabs. In practical production, a plurality of electrode-sheet tabs belonging to a positive electrode are connected together and then externally connected to a positive tab, and a plurality of electrode-sheet tabs belonging to a negative electrode are connected together and then externally connected to a negative tab, thus forming a basic battery structure.

To reduce the volume occupied by the positive tab and the negative tab in the packaging space during packaging, to-be-packaged portions of the positive tab and the negative tab are usually folded, and the packaging space of the packaging member 150 is configured according to the volume of the folded portions, so as to avoid excessive waste of packaging space that would otherwise affect the energy density of the battery. The packaging member 150 may be an aluminum-plastic film or a metal casing.

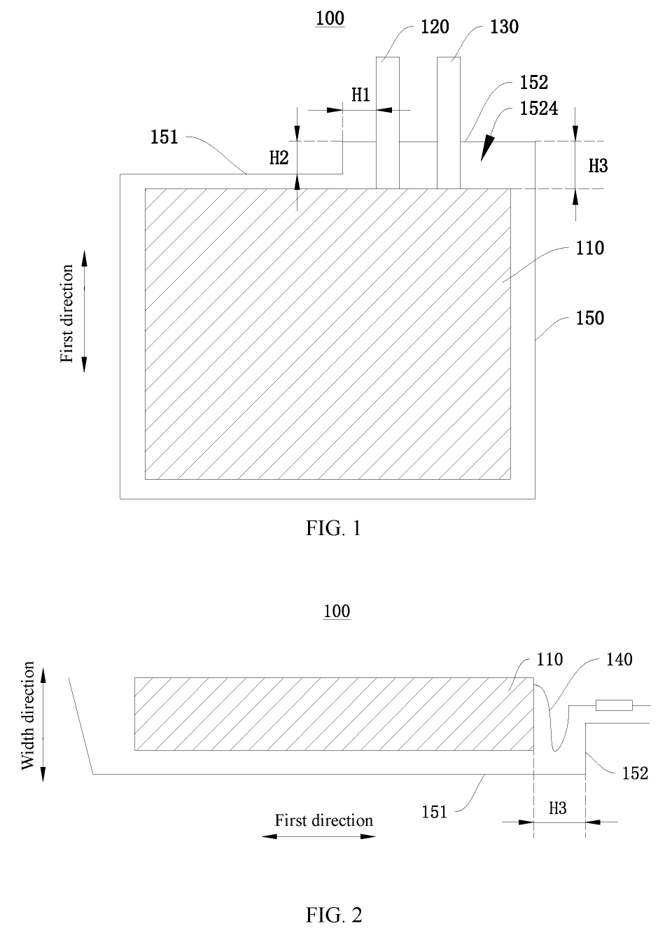

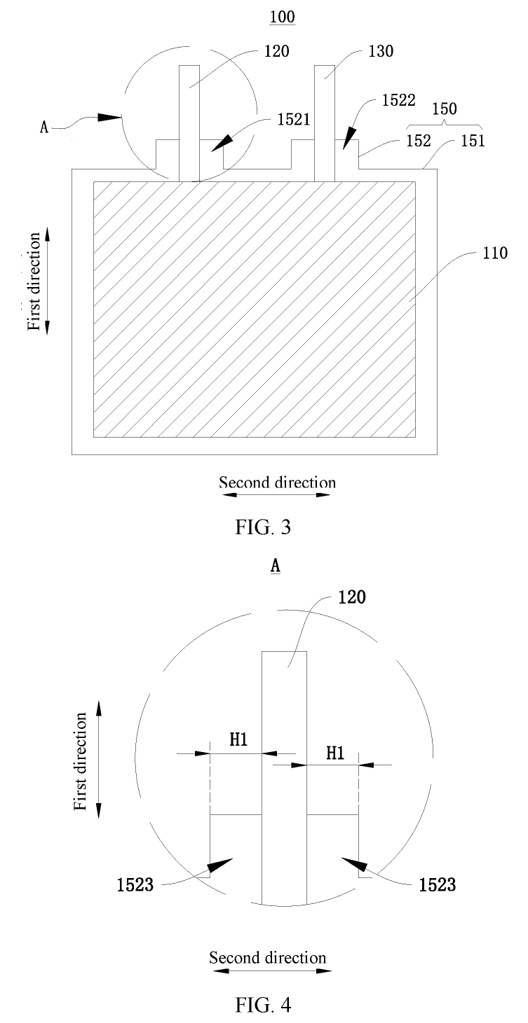

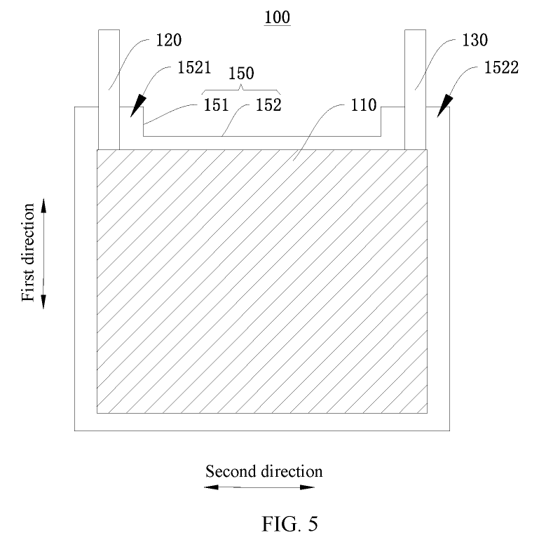

Refer to FIG. 1 to FIG. 5. It should be noted that FIG. 1 to FIG. 5 are cross-sectional views. In accordance with a first aspect of the present disclosure, an embodiment provides a cell 100, which includes an electrode assembly 110, a first tab 120, a second tab 130, and a packaging member 150. The first tab 120 is connected to the electrode assembly 110. The second tab 130 is connected to the electrode assembly 110. The first tab 120 and the second tab 130 are located on the same side of the electrode assembly 110. The packaging member 150 includes an electrode assembly accommodating portion 151 and a tab packaging portion 152. The tab packaging portion 152 is in communication with the electrode assembly accommodating portion 151. The tab packaging portion 152 extends away from the electrode assembly accommodating portion 151 in a first direction. A size of the tab packaging portion 152 is smaller than a size of the electrode assembly accommodating portion 151 in a second direction. The first direction is perpendicular to the second direction. The term "perpendicular" as used herein allows for a deviation angle within an allowable tolerance range. The first tab 120 and the second tab 130 are each provided with a bending portion 140 extending in a thickness direction of the electrode assembly 110. The electrode assembly 110 is accommodated in the electrode assembly accommodating portion 151. The bending portions 140 are accommodated in the tab packaging portion 152. One of the first tab 120 and the second tab 130 is a positive tab and the other is a negative tab. It should be noted that the first direction may be a length direction of the electrode assembly 110, and the second direction may be a width direction of the electrode assembly 110.

In the cell 100, the first tab 120 and the second tab 130 are respectively connected to the same side of the electrode assembly 110. When the cell 100 is applied to a device, the device may be provided with an input end corresponding to the first tab 120 and the second tab 130 of the electrode assembly 110 to electrically connect to the first tab 120 and the second tab 130 to ensure power supply. As such, the rationality of the layout of the components in the device and the convenience of mounting the cell 100 are improved.

In the first direction, the first tab 120 and the second tab 130 protrude from the electrode assembly 110. In the packaging process of the cell 100, it is necessary to fold a to-be-packaged portion of each of the first tab 120 and the second tab 130 to form a bending portion 140, so that when the electrode assembly 110, the first tab 120, and the second tab 130 are packaged by the packaging member 150, the electrode assembly 110 is accommodated in the electrode assembly accommodating portion 151 of the packaging member 150, and the bending portions 140 are accommodated in the tab packaging portion 152 extending away from the electrode assembly accommodating portion 151 in the first direction. As such, the electrode assembly accommodating portion 151 and the tab packaging portion 152 of the packaging member 150 can be respectively designed according to actual dimensions of the electrode assembly 110, the first tab 120, and the second tab 130, thereby reducing the waste of space caused by designing the dimensions of the packaging member 150 based on the space required by the bending portions 140 with no tab area being provided in the packaged cell 100. Such a method can not only increase the energy density of the packaged cell 100, but also reduce the unoccupied space between the packaging member 150 and the electrode assembly 110 where no tab region is provided, making the overall structure of the packaged electrode assembly 110 more compact, and making the electrode assembly 110 less likely to shake in the electrode assembly accommodating portion 151, thereby improving the stability of the cell 100.

It should be noted that the first tab 120 and the second tab 130 may be bent in the thickness direction of the electrode assembly 110, so that the dimensions can be reduced as much as possible by one folding, so as to maximize the utilization of space in the thickness direction of the electrode assembly 110 and reduce the volume of the bending portions 140 formed after bending, thereby reducing the overall package volume and improving the energy density of the packaged cell 100. In addition, the size of the tab packaging portion 152 in the second direction is smaller than the size of the electrode assembly accommodating portion 151, to facilitate positioning of the packaging positions of the tabs and the electrode assembly 110 while reducing the volume of the cell 100 after packaging, thereby improving the packaging precision and packaging speed.

Further, the electrode assembly accommodating portion includes an electrode assembly accommodating cavity configured to accommodate the electrode assembly 110, and the tab packaging portion includes a tab packaging cavity configured to accommodate the first tab 120 and the second tab 130.

The electrode assembly 110 of the cell 100 may be formed by winding or lamination. In the electrode assembly 110 with multiple electrode-sheet tabs, a plurality of electrode-sheet tabs belonging to a positive electrode are connected together and then externally connected to one of the first tab 120 and the second tab 130, and a plurality of electrode-sheet tabs belonging to a negative electrode are connected together and then externally connected to the other of the first tab 120 and the second tab 130.

When the cell 100 is applied to a device, the unoccupied space between the packaging member 150 and the electrode assembly 110 where no tab region is provided is reduced, and the mounting space occupied by the packaged cell 100 in the device is reduced, so that the utilization of space in the device is improved. The device may be a mobile phone. Because the space occupied by the cell 100 in the device is reduced, the saved space can be used for arranging other components of the mobile phone, so that the utilization of space in the mobile phone is improved, facilitating the optimization of the mobile phone.

Referring to FIG. 1 to FIG. 4, according to an embodiment of the present disclosure, in the cell 100, the tab packaging portion 152 includes a first packaging portion 1521 and a second packaging portion 1522, the first tab 120 is accommodated in the first packaging portion 1521, and the second tab 130 is accommodated in the second packaging portion 1522. The first packaging portion 1521 and the second packaging portion 1522 are arranged spaced apart from each other in the second direction. When the cell 100 is packaged, the electrode assembly 110 is accommodated in the electrode assembly accommodating portion 151 of the packaging member 150, and the first tab 120 and the second tab 130 are accommodated in the tab packaging portion 152. The first tab 120 is accommodated in the first packaging portion 1521, the second tab 130 is accommodated in the second packaging portion 1522, and the first packaging portion 1521 and the second packaging portion 1522 are arranged spaced apart from each other in the second direction, to facilitate the localization of the packaging positions of the first tab 120 and the second tab 130 and prevent the first tab 120 and the second tab 130 from interfering with each other. This also facilitates the manufacturing of the cell 100. For example, when the first tab 120 and the second tab 130 are connected to the electrode assembly 110 by welding, the first packaging portion 1521 and the second packaging portion 1522 are arranged spaced apart from each other in the second direction, to prevent the first packaging portion 1521 and the second packaging portion 1522 from interfering with each other, thereby ensuring the welding quality. In addition, because the first packaging portion 1521 and the second packaging portion 1522 are arranged spaced apart from each other, the packaging space between the first packaging portion 1521 and the second packaging portion 1522 can be reduced, thereby increasing the energy density of the packaged cell 100.

When the cell 100 is applied to a device, the volume occupied by the cell 100 in the device can be reduced, thereby improving the utilization of space in the device, and facilitating the expansion of functions of the device. The device may be a mobile phone. Because the first packaging portion 1521 and the second packaging portion 1522 are arranged spaced apart from each other, space between the first packaging portion 1521 and the second packaging portion 1522 in the packaged cell 100 can be used for arranging other components of the mobile phone, so that the utilization of space in the mobile phone is improved.

Referring to FIG. 1 to FIG. 5, according to an embodiment of the present disclosure, in the cell 100, opposing edges of the first packaging portion 1521 and the second packaging portion 1522 are respectively arranged to be flush with an edge of the electrode assembly accommodating portion 151 in the second direction. When the cell 100 is packaged, the electrode assembly 110 is accommodated in the electrode assembly accommodating portion 151 of the packaging member 150, and the first tab 120 and the second tab 130 are accommodated in the tab packaging portion 152. The first tab 120 is accommodated in the first packaging portion 1521, the second tab 130 is accommodated in the second packaging portion 1522, and opposing edges of the first packaging portion 1521 and the second packaging portion 1522 are respectively arranged to be flush with an edge of the electrode assembly accommodating portion 151 in the second direction. Compared with the configuration in which opposing edges of the first packaging portion 1521 and the second packaging portion 1522 are respectively arranged to be not flush with the edges of the electrode assembly accommodating portion 151 in the second direction, such a configuration enables the packaged cell 100 to have a regular structure. When the cell 100 is applied to a device, the space between the first packaging portion 1521 and the second packaging portion 1522 is relatively regular, and can be used for arranging other components of the device. This improves the rationality of the layout of the components in the device and also facilitates the assembly of the cell 100 with the device.

It should be noted that the regular outer contour of the cell 100 can reduce the complexity of providing an accommodating space in the device to accommodate the cell 100. In addition, when the packaging member 150 is a metal casing and the first packaging portion 1521 and the second packaging portion 1522 are stamped from the metal casing, the shape of the stamping die is relatively simple, which is conducive to improving the efficiency of die design.

In addition, the packaging member 150 may be a metal casing, the first packaging portion 1521, the second packaging portion 1522, and the electrode assembly accommodating portion 151 are casing structures having an accommodating cavity formed by stamping, and opposing cavity walls of the first packaging portion 1521 and the second packaging portion 1522 are arranged to be flush with a cavity wall of the electrode assembly accommodating portion 151, to simplify the stamping die design process and improve the efficiency of the stamping operation. The packaging member 150 may also be an aluminum-plastic film, and opposing cavity walls of the first packaging portion 1521 and the second packaging portion 1522 are arranged to be flush with a cavity wall of the electrode assembly accommodating portion 151, to simplify a head structure used for top sealing during packaging and reduce production costs.

Referring to FIG. 1 to FIG. 5, according to an embodiment of the present disclosure, in the cell 100, an accommodating cavity 1523 is defined between any edge of the first tab 120 in the second direction and an inner side wall of the first packaging portion 1521 opposite to the edge, and a size of the accommodating cavity 1523 in the second direction is 2.0 mm to 15.0 mm. Additionally or alternatively, an accommodating cavity 1523 is defined between any edge of the second tab 130 in the second direction and an inner side wall of the second packaging portion 1522 opposite to the edge, and a size of the accommodating cavity 1523 in the second direction is 2.0 mm to 15.0 mm.

By the above structure, in the packaging process of the cell 100, the electrode assembly 110 is accommodated in the electrode assembly accommodating portion 151 of the packaging member 150, the bending portion 140 of the first tab 120 is accommodated in the first packaging portion 1521, and the bending portion 140 of the second tab 130 is accommodated in the second packaging portion 1522. As such, the dimensions of the first packaging portion 1521 and the second packaging portion 1522 are reduced while ensuring sufficient space for accommodating the first tab 120 and the second tab 130, thereby improving the energy density of the packaged cell 100. A size of the accommodating cavity 1523 in the second direction is 2.0 mm to 15.0 mm, i.e., a distance indicated by H1 in FIG. 1 and FIG. 4.

In a first embodiment, when the cell 100 is packaged, the electrode assembly 110 is accommodated in the electrode assembly accommodating portion 151 of the packaging member 150, the bending portion 140 of the first tab 120 is accommodated in the first packaging portion 1521, and the bending portion 140 of the second tab 130 is accommodated in the second packaging portion 1522. Projected in the thickness direction of the electrode assembly 110, an accommodating cavity 1523 is defined between any edge of the first tab 120 in the second direction and an inner side wall of the first packaging portion 1521 opposite to the edge, and a size of the accommodating cavity 1523 in the second direction is 2.0 mm to 15.0 mm;

In a second embodiment, when the cell 100 is packaged, the electrode assembly 110 is accommodated in the electrode assembly accommodating portion 151 of the packaging member 150, the bending portion 140 of the first tab 120 is accommodated in the first packaging portion 1521, and the bending portion 140 of the second tab 130 is accommodated in the second packaging portion 1522. An accommodating cavity 1523 is defined between any edge of the second tab 130 in the second direction and an inner side wall of the second packaging portion 1522 opposite to the edge, and a size of the accommodating cavity 1523 in the second direction is 2.0 mm to 15.0 mm.

In a third embodiment, when the cell 100 is packaged, the electrode assembly 110 is accommodated in the electrode assembly accommodating portion 151 of the packaging member 150, the bending portion 140 of the first tab 120 is accommodated in the first packaging portion 1521, and the bending portion 140 of the second tab 130 is accommodated in the second packaging portion 1522. An accommodating cavity 1523 is defined between any edge of the first tab 120 in the second direction and an inner side wall of the first packaging portion 1521 opposite to the edge, and a size of the accommodating cavity 1523 in the second direction is 2.0 mm to 15.0 mm. An accommodating cavity 1523 is defined between any edge of the second tab 130 in the second direction and an inner side wall of the second packaging portion 1522 opposite to the edge, and a size of the accommodating cavity 1523 in the second direction is 2.0 mm to 15.0 mm.

It should be noted that when the cell 100 is formed by winding or lamination, there are respectively a plurality of stacked electrode-sheet tabs in a positive tab connection portion and a negative tab connection portion, and during packaging, these electrode-sheet tabs need to occupy the packaging space of the packaging member 150. Taking the electrode-sheet tabs belonging to the positive tab connection portion as an example, a plurality of electrode-sheet tabs are stacked and connected in the thickness direction of the electrode assembly 110. Using one of the electrode-sheet tabs as a reference tab, portions of the other electrode-sheet tabs protruding from the reference tab in the second direction can be accommodated in the accommodating cavity 1523, to reduce the impact of imprecise alignment during stacking and connection of the plurality of electrode-sheet tabs, thereby ensuring the quality of the cell 100. Similarly, imprecise alignment may also occur during stacking of the electrode-sheet tabs belonging to the negative tab connection portion, and the arrangement of the accommodating cavity 1523 can reduce the impact of imprecise alignment of the electrode-sheet tabs belonging to the negative tab connection portion, thereby ensuring the packaging of the cell 100.

In addition, the size of the accommodating cavity 1523 in the second direction is 2.0 mm to 15.0 mm, so that the waste of the overall packaging space of the packaging member 150 can be reduced while ensuring a smooth packaging process of the cell 100, thereby improving the energy density of the cell 100.

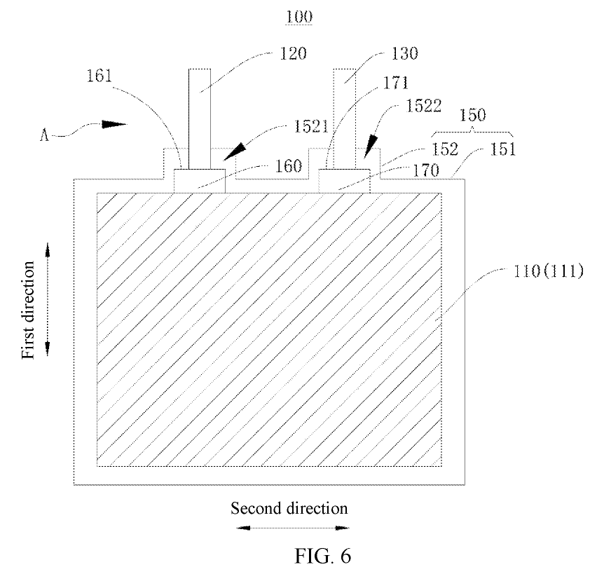

Referring to FIG. 1 to FIG. 6, according to an embodiment of the present disclosure, in the cell 100, the electrode assembly 110 includes an electrode assembly body 111, a first tab portion 160, and a second tab portion 170, the first tab portion 160 and the second tab portion 170 are connected to the electrode assembly body 111 and protrude from the electrode assembly body 111, the first tab portion 160 is connected to the first tab 120, and the second tab portion 170 is connected to the second tab 130; and the first tab portion 160 protrudes from the first tab 120 in the second direction to form a protruding portion 161, and the protruding portion 161 is accommodated in the accommodating cavity 1523; and/or the second tab portion 170 protrudes from the second tab 130 in the second direction to form a protruding portion 171, and the protruding portion 171 is accommodated in the accommodating cavity 1523.

When the cell 100 is packaged, the electrode assembly 110 is accommodated in the electrode assembly accommodating portion 151 of the packaging member 150, a position where the first tab 120 is connected to the first tab portion 160 is accommodated in the first packaging portion 1521, and a position where the second tab 130 is connected to the second tab portion 170 is accommodated in the second packaging portion 1522, so that the first tab portion 160 protrudes from the first tab 120 in the second direction to form a protruding portion 161 which is accommodated in the accommodating cavity 1523, and/or the second tab portion 170 protrudes from the second tab 130 in the second direction to form a protruding portion 171 which is accommodated in the accommodating cavity 1523, thereby ensuring the smooth packaging of the electrode assembly 110, the first tab 120, and the second tab 130 and improving the packaging quality.

In a first embodiment, the electrode assembly 110 includes an electrode assembly body 111, a first tab portion 160, and a second tab portion 170, the first tab portion 160 and the second tab portion 170 are connected to the electrode assembly body 111 and protrude from the electrode assembly body 111, the first tab portion 160 is connected to the first tab 120, and the second tab portion 170 is connected to the second tab 130; and the first tab portion 160 protrudes from the first tab 120 in the second direction to form a protruding portion 161, and the protruding portion 161 is accommodated in the accommodating cavity 1523, to ensure the packaging quality.

In a second embodiment, the electrode assembly 110 includes an electrode assembly body 111, a first tab portion 160, and a second tab portion 170, the first tab portion 160 and the second tab portion 170 are connected to the electrode assembly body 111 and protrude from the electrode assembly body 111, the first tab portion 160 is connected to the first tab 120, and the second tab portion 170 is connected to the second tab 130; and the second tab portion 170 protrudes from the second tab 130 in the second direction to form a protruding portion 171, and the protruding portion 171 is accommodated in the accommodating cavity 1523, to ensure the packaging quality.

In a third embodiment, the electrode assembly 110 includes an electrode assembly body 111, a first tab portion 160, and a second tab portion 170, the first tab portion 160 and the second tab portion 170 are connected to the electrode assembly body 111 and protrude from the electrode assembly body 111, the first tab portion 160 is connected to the first tab 120, and the second tab portion 170 is connected to the second tab 130; the first tab portion 160 protrudes from the first tab 120 in the second direction to form a protruding portion 161, and the protruding portion 161 is accommodated in the accommodating cavity 1523; and the second tab portion 170 protrudes from the second tab 130 in the second direction to form a protruding portion 171, and the protruding portion 171 is accommodated in the accommodating cavity 1523, to ensure the packaging quality.

It should be noted that when the electrode assembly 110 is formed by winding or lamination, there are a plurality of electrode-sheet tabs, a part of the electrode-sheet tabs are stacked and connected to form a first tab portion 160, another part of the electrode-sheet tabs are stacked and connected to form a second tab portion 170, the first tab portion 160 is connected to the first tab 120, and the second tab portion 170 is connected to the second tab 130. Taking the electrode-sheet tabs belonging to the first tab portion 160 as an example, a plurality of electrode-sheet tabs are stacked and connected in the thickness direction of the electrode assembly 110. Using one of the electrode-sheet tabs as a reference tab, portions of the other electrode-sheet tabs protruding from the reference tab in the second direction can be accommodated in the accommodating cavity 1523, to reduce the impact of imprecise alignment during stacking and connection of the plurality of electrode-sheet tabs, thereby ensuring the quality of the cell 100. Similarly, imprecise alignment may also occur during stacking of the electrode-sheet tabs belonging to the second tab portion 170, and the arrangement of the accommodating cavity 1523 can reduce the impact of imprecise alignment of the electrode-sheet tabs belonging to the second tab portion 170, thereby ensuring the packaging of the cell 100.

In addition, the size of the accommodating cavity 1523 in the second direction is 2.0 mm to 15.0 mm, so that the waste of the overall packaging space of the packaging member 150 can be reduced while ensuring a smooth packaging process of the cell 100, thereby improving the energy density of the cell 100.

Referring to FIG. 1 to FIG. 6, according to an embodiment of the present disclosure, in the cell 100, the tab packaging portion 152 is provided with a tab packaging cavity 1524, and the bending portions 140 of the first tab 120 and the second tab 130 are accommodated in the tab packaging cavity 1524. When the cell 100 is packaged, the electrode assembly 110 is accommodated in the electrode assembly accommodating portion 151 of the packaging member 150, and the first tab 120 and the second tab 130 are accommodated in the tab packaging portion 152. The bending portions 140 of the first tab 120 and the second tab 130 are both accommodated in the tab packaging cavity 1524. Compared with the arrangement of the first packaging portion 1521 and the second packaging portion 1522 spaced apart from each other in the second direction, such a structure facilitates processing or production of the packaging member 150, and makes the structure of the packaged cell 100 more regular. When applied to a device, the cell 100 using such a structure can better integrate with components in the device during assembly, thereby optimizing the layout of the components in the mounting space in the device, and improving space utilization and orderliness.

It should be noted that in the above embodiments, the tab packaging portion 152 may be an integral structure provided therein with a cavity as the tab packaging cavity 1524.

In addition, if the packaging member 150 is a metal casing, the above structure can simplify the design of the metal casing stamping die and reduce the design and manufacturing costs of the die. If the packaging member 150 is an aluminum-plastic film, the above structure can simplify the head structure used for top sealing during packaging and reduce the design and manufacturing costs of the head.

Referring to FIG. 1 to FIG. 6, according to an embodiment of the present disclosure, in the cell 100, one edge of the tab packaging portion 152 in the second direction is arranged to be flush with an edge of the electrode assembly accommodating portion 151. When the cell 100 is packaged, the electrode assembly 110 is accommodated in the electrode assembly accommodating portion 151 of the packaging member 150, and the first tab 120 and the second tab 130 are accommodated in the tab packaging portion 152. The bending portions 140 of the first tab 120 and the second tab 130 are both accommodated in the tab packaging cavity 1524, and one edge of the tab packaging portion 152 in the second direction is arranged to be flush with the edge of the electrode assembly accommodating portion 151, so that the structure of the packaging member 150 is relatively regular, which can simplify the processing operations of the packaging member 150 or shorten the production time. Therefore, the structure of the packaged cell 100 is relatively regular, and the packaged cell 100 can be assembled more conveniently and efficiently when applied to a device.

Referring to FIG. 1 and FIG. 2, according to an embodiment of the present disclosure, in the cell 100, a size of the tab packaging portion 152 in the first direction is 0.3 mm to 5.0 mm, i.e., a distance indicated by H2 in FIG. 1. When the size of the tab packaging portion 152 in the first direction is 0.3 mm to 5.0 mm, the bending portions 140 of the first tab 120 and the second tab 130 can both be accommodated in the tab packaging portion 152, so that the waste of the overall packaging space of the packaging member 150 can be reduced while ensuring a smooth packaging process of the cell 100, thereby improving the energy density of the cell 100.

Referring to FIG. 1 to FIG. 3, according to an embodiment of the present disclosure, in the cell 100, a distance from one edge of the electrode assembly 110 facing the tab packaging portion 152 in the first direction to one edge of the tab packaging portion 152 away from the electrode assembly accommodating portion 151 is 0.5 mm to 5.5 mm, i.e., a distance indicated by H3 in FIG. 1. When the cell 100 is packaged, the electrode assembly 110 is accommodated in the electrode assembly accommodating portion 151 of the packaging member 150, and the first tab 120 and the second tab 130 are accommodated in the tab packaging portion 152. Projected in the thickness direction of the electrode assembly 110, the distance from one edge of the electrode assembly 110 facing the tab packaging portion 152 in the first direction to one edge of the tab packaging portion 152 away from the electrode assembly accommodating portion 151 is 0.5 mm to 5.5 mm, so that the waste of the overall packaging space of the packaging member 150 can be reduced while ensuring sufficient space for packaging the bending portions 140, thereby improving the energy density of the cell 100.

Referring to FIG. 1 to FIG. 6, in accordance with a second aspect of the present disclosure, an embodiment provides an electronic device including the cell 100 of the embodiments of the first aspect of the present disclosure. The electronic device is provided with an accommodating cavity to accommodate the cell 100 and other components. In the cell 100, the first tab 120 and the second tab 130 are respectively connected to the same side of the electrode assembly 110. When the cell 100 is applied to a device, the device may be provided with an input end corresponding to the first tab 120 and the second tab 130 of the electrode assembly 110 to electrically connect to the first tab 120 and the second tab 130 to ensure power supply. As such, the rationality of the layout of the components in the device and the convenience of mounting the cell 100 are improved. In the packaging process of the cell 100, the electrode assembly 110 is accommodated in the electrode assembly accommodating portion 151 of the packaging member 150, and the bending portions 140 are accommodated in the tab packaging portion 152 extending away from the electrode assembly accommodating portion 151 in the first direction. As such, the electrode assembly accommodating portion 151 and the tab packaging portion 152 of the packaging member 150 can be respectively designed according to actual dimensions of the electrode assembly 110, the first tab 120, and the second tab 130, thereby reducing the waste of space caused by designing the dimensions of the packaging member 150 based on the space required by the bending portions 140 with no tab area being provided in the packaged cell 100. Such a method can not only increase the energy density of the packaged cell 100, but also reduce the unoccupied space between the packaging member 150 and the electrode assembly 110 where no tab region is provided, making the overall structure of the packaged electrode assembly 110 more compact, and making the electrode assembly 110 less likely to shake in the electrode assembly accommodating portion 151, thereby improving the stability of the cell 100. Finally, when the cell 100 is accommodated in the accommodating cavity to supply power to the electronic device, the overall volume of the cell is reduced and the energy density is increased, because the unoccupied space between the packaging member and the electrode assembly 110 where no tab region is provided is reduced in the cell. When installed in the electronic device, the cell occupies a small part of the mounting space in the electronic device, which is conducive to improving the flexibility and rationality of the layout of the components in the electronic device.

It should be noted that because the cell according to the embodiments of the first aspect is used in this embodiment, this embodiment has all the beneficial effects brought by the embodiments of the first aspect, which will not be repeatedly described herein.

The embodiments of the present disclosure have been described in detail above with reference to the accompanying drawings, but the present disclosure is not limited to the above embodiments, and various changes may be made within the knowledge of those having ordinary skills in the art without departing from the gist of the present disclosure. In addition, the embodiments of the present disclosure and the features in the embodiments may be combined with each other without conflict.

What is claimed is:

1. A cell, comprising:
an electrode assembly;
a first tab, connected to the electrode assembly;
a second tab, connected to the electrode assembly, wherein the first tab and the second tab are located on the same side of the electrode assembly; and
a packaging member, comprising an electrode assembly accommodating portion and a tab packaging portion, wherein the tab packaging portion is in communication with the electrode assembly accommodating portion, the tab packaging portion extends away from the electrode assembly accommodating portion in a first direction, a size of the tab packaging portion is smaller than a size of the electrode assembly accommodating portion in a second direction, and the first direction is perpendicular to the second direction;
wherein the first tab and the second tab are each provided with a bending portion extending in a thickness direction of the electrode assembly, the electrode assembly is accommodated in the electrode assembly accommodating portion, and the bending portions are accommodated in the tab packaging portion.

2. The cell of claim 1, wherein the tab packaging portion comprises a first packaging portion and a second packaging portion, the first tab is accommodated in the first packaging portion, and the second tab is accommodated in the second packaging portion,
wherein the first packaging portion and the second packaging portion are arranged spaced apart from each other in the second direction.

3. The cell of claim 2, wherein opposing edges of the first packaging portion and the second packaging portion are respectively arranged to be flush with an edge of the electrode assembly accommodating portion in the second direction.

4. The cell of claim 2, wherein an accommodating cavity is defined between any edge of the first tab in the second direction and an inner side wall of the first packaging portion opposite to the edge, and a size of the accommodating cavity in the second direction is 2.0 mm to 15.0 mm; and/or
an accommodating cavity is defined between any edge of the second tab in the second direction and an inner side wall of the second packaging portion opposite to the edge, and a size of the accommodating cavity in the second direction is 2.0 mm to 15.0 mm.

5. The cell of claim 4, wherein the electrode assembly comprises an electrode assembly body, a first tab portion, and a second tab portion, the first tab portion and the second tab portion are connected to the electrode assembly body and protrude from the electrode assembly body, the first tab portion is connected to the first tab, and the second tab portion is connected to the second tab; and
the first tab portion protrudes from the first tab in the second direction to form a protruding portion, and the protruding portion is accommodated in the accommodating cavity; and/or
the second tab portion protrudes from the second tab in the second direction to form a protruding portion, and the protruding portion is accommodated in the accommodating cavity.

6. The cell of claim 1, wherein the tab packaging portion is provided with a tab packaging cavity, and the bending portions of the first tab and the second tab are accommodated in the tab packaging cavity.

7. The cell of claim 1, wherein one edge of the tab packaging portion in the second direction is arranged to be flush with an edge of the electrode assembly accommodating portion.

8. The cell of claim 1, wherein a size of the tab packaging portion in the first direction is 0.3 mm to 5.0 mm.

9. The cell of claim 1, wherein a distance from one edge of the electrode assembly facing the tab packaging portion in the first direction to one edge of the tab packaging portion away from the electrode assembly accommodating portion is 0.5 mm to 5.5 mm.

10. An electronic device, comprising a housing and a plurality of cells arranged in the housing, each of the cells comprising:
an electrode assembly;
a first tab, connected to the electrode assembly;
a second tab, connected to the electrode assembly, wherein the first tab and the second tab are located on the same side of the electrode assembly; and
a packaging member, comprising an electrode assembly accommodating portion and a tab packaging portion, wherein the tab packaging portion is in communication with the electrode assembly accommodating portion, the tab packaging portion extends away from the electrode assembly accommodating portion in a first direction, a size of the tab packaging portion is smaller than a size of the electrode assembly accommodating portion in a second direction, and the first direction is perpendicular to the second direction;
wherein the first tab and the second tab are each provided with a bending portion extending in a thickness direction of the electrode assembly, the electrode assembly is accommodated in the electrode assembly accommodating portion, and the bending portions are accommodated in the tab packaging portion.

11. The electronic device of claim 10, wherein the tab packaging portion comprises a first packaging portion and a second packaging portion, the first tab is accommodated in the first packaging portion, and the second tab is accommodated in the second packaging portion,
wherein the first packaging portion and the second packaging portion are arranged spaced apart from each other in the second direction.

12. The electronic device of claim 11, wherein opposing edges of the first packaging portion and the second packaging portion are respectively arranged to be flush with an edge of the electrode assembly accommodating portion in the second direction.

13. The electronic device of claim 11, wherein an accommodating cavity is defined between any edge of the first tab in the second direction and an inner side wall of the first packaging portion opposite to the edge, and a size of the accommodating cavity in the second direction is 2.0 mm to 15.0 mm; and/or
an accommodating cavity is defined between any edge of the second tab in the second direction and an inner side wall of the second packaging portion opposite to the edge, and a size of the accommodating cavity in the second direction is 2.0 mm to 15.0 mm.

14. The electronic device of claim 13, wherein the electrode assembly comprises an electrode assembly body, a first tab portion, and a second tab portion, the first tab portion and the second tab portion are connected to the electrode assembly body and protrude from the electrode assembly body, the first tab portion is connected to the first tab, and the second tab portion is connected to the second tab; and
the first tab portion protrudes from the first tab in the second direction to form a protruding portion, and the protruding portion is accommodated in the accommodating cavity; and/or
the second tab portion protrudes from the second tab in the second direction to form a protruding portion, and the protruding portion is accommodated in the accommodating cavity.

15. The electronic device of claim 10, wherein the tab packaging portion is provided with a tab packaging cavity, and the bending portions of the first tab and the second tab are accommodated in the tab packaging cavity.

16. The electronic device of claim 10, wherein one edge of the tab packaging portion in the second direction is arranged to be flush with an edge of the electrode assembly accommodating portion.

17. The electronic device of claim 10, wherein a size of the tab packaging portion in the first direction is 0.3 mm to 5.0 mm.

18. The electronic device of claim 10, wherein a distance from one edge of the electrode assembly facing the tab packaging portion in the first direction to one edge of the tab packaging portion away from the electrode assembly accommodating portion is 0.5 mm to 5.5 mm.
